(19) United States
(12) Patent Application Publication
(10) Pub. No.: US 2010/0222433 A1
(43) Pub. Date: Sep. 2, 2010

(54) Composite Disinfectant Cleaner

(76) Inventors: Jialu Xue, Shanghai (CN); Yinping Ren, Shanghai (CN); Yue Wang, Shanghai (CN); Xiaoping Ren, Shanghai (CN); Zhonghua Xue, Shanghai (CN); Jinhua Ren, Shanghai (CN)

Correspondence Address: Yinping Ren, 55 West Beaver Creek Road, Unit 16, Richmond Hill, ON, L4B1K5, omitted

(21) Appl. No.: 12/714,852

(22) Filed: Mar. 1, 2010

(30) Foreign Application Priority Data
Mar. 2, 2009 (CN) 200910046868. 4

(51) Int. Cl. A01N 37/52; A01P 1/00

(52) U.S. Cl. 514/634

(57) ABSTRACT

A disinfectant cleaner is provided by combining an alkyl dimethyl benzyl ammonium chloride, an octyl decyl dimethyl ammonium chloride, a dioctyl dimethyl ammonium chloride, a didecyl dimethyl ammonium chloride, an alkylamine, a guanidine, a penetrant, a surfactant, a chelant, an essence and deionized water.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

This application relates to disinfectants, specifically to composite disinfectant cleaners. Disinfection is defined as cleaning pathogenic microorganisms on an article. According to the purpose, there are two types of disinfection: disinfection of epidemic focus, and preventive disinfection. Disinfection is directed against the pathogenic microorganisms, but not all microorganisms. In addition, the process only reduces the pathogenic microorganisms to a safe level, not destroys all pathogenic microorganisms. Disinfectants are antimicrobial agents that are applied to clean pathogenic microorganisms on an article. Usually, disinfectants are chemical compounds. Disinfectant cleaners are disinfectants with cleaning performance. The ideal disinfectant cleaner should have the following characteristics: high kill capability for pathogenic bacteria, strong cleaning performance, rapid action, stability, ease to store and transport, non-toxic, non-irritating, activity in presence of water, non-staining, free from contamination, not inflammable, not explosive, safe and easy to use, low effective concentration, and inexpensive.

Although an extensive number of disinfectant cleaners are commercially available, all of them heretofore known suffer from a number of disadvantages: limited disinfection and cleaning performance, slow action, toxic, or irritating. Thus, it is understood that there is a present and continuing need for disinfectant cleaners which simultaneously disinfect, clean well, and are rapid action, non-toxic, and non-irritating. In addition, there is presently no any composite disinfectant cleaner manufactured by cationic combination of alkyl dimethyl benzyl ammonium chloride, octyl decyl dimethyl ammonium chloride, dioctyl dimethyl ammonium chloride, didecyl dimethyl ammonium chloride, alkylamine, penetrants and surfactants.

### SUMMARY

A composite disinfectant cleaner comprises an alkyl dimethyl benzyl ammonium chloride, an octyl decyl dimethyl ammonium chloride, a dioctyl dimethyl ammonium chloride, a didecyl dimethyl ammonium chloride, an alkylamine, a guanidine, a penetrant, a surfactant, a chelant, an essence and deionized water.

### DETAILED DESCRIPTION

### Composition

The problem described in background, on which the application is based, was solved by using a mixture of following composition:
a. about 0.5-0.7 weight percent of an alkyl dimethyl benzyl ammonium chloride
b. about 0.3-0.5 weight percent of an octyl decyl dimethyl ammonium chloride
c. about 0.1-0.2 weight percent of a dioctyl dimethyl ammonium chloride
d. about 0.2-0.3 weight percent of a didecyl dimethyl ammonium chloride
e. about 0.5-2 weight percent of an alkylamine
f. about 0.3-1.5 weight percent of a guanidine
g. about 10-20 weight percent of a penetrant
h. about 5-10 weight percent of a surfactant
i. about 0.1-0.6 weight percent of a chelant
j. about 0.05-0.1 weight percent of an essence
k. the balance being deionized water

The composition above wherein said alkylamine is one of cetyl amidopropyl glycine, cetyl propylenediamine, cetyl dipropylenetriamine or their compounds; guanidines is one of polihexanide, cyclohexen biguanide, chlorhexidine hydrochloride, chlorhexidine acetate or their compounds; penetrant is one of ethanol, isopropanol, ethyl glycol, ethylene glycol monobutyl, propylene glycol monomethyl ether, diethylene glycol monoethyl ether, dipropylene glycol methyl ether or their compounds; surfactant is one of lauryl dimethyl amine oxide, octyl dimethyl amine oxide, polyoxyethylene nonylphenol ether, dodecyl dimethyl betaine or their compounds; essence is one of lavender essence, aloe essence, or lemon essence.

### EMBODIMENT 1

One embodiment of the composition is described in more detail below:
a. 0.4 weight percent of an alkyl dimethyl benzyl ammonium chloride
b. 0.5 weight percent of an octyl decyl dimethyl ammonium chloride
c. 0.15 weight percent of a dioctyl dimethyl ammonium chloride
d. 0.2 weight percent of a didecyl dimethyl ammonium chloride
e. 0.5 weight percent of a cetyl propylenediamine
f. 0.4 weight percent of a chlorhexidine acetate
g. 5 weight percent of a propylene glycol monomethyl ether
h. 10 weight percent of an ethanol
i. 5 weight percent of an isopropanol
j. 6 weight percent of a polyoxyethylene nonylphenol ether
k. 4 weight percent of a lauryl dimethyl amine oxide
l. 0.1 weight percent of a tetrasodium ethylene diamine tetraacetate
m. 0.05 weight percent of an essence
n. the balance being deionized water.

### EMBODIMENT 2

Additional embodiment of the composition is described in more detail below:
a. 0.7 weight percent of an alkyl dimethyl benzyl ammonium chloride
b. 0.35 weight percent of an octyl decyl dimethyl ammonium chloride
c. 0.2 weight percent of a dioctyl dimethyl ammonium chloride
d. 0.3 weight percent of a didecyl dimethyl ammonium chloride
e. 0.5 weight percent of a cetyl amidopropyl glycine
f. 0.3 weight percent of a polihexanide
g. 4 weight percent of a propylene glycol monomethyl ether
h. 12 weight percent of an ethanol
i. 4 weight percent of an isopropanol
j. 6 weight percent of a polyoxyethylene nonylphenol ether
k. 4 weight percent of a dodecyl dimethyl betaine
l. 0.1 weight percent of a tetrasodium ethylene diamine tetraacetate
m. 0.1 weight percent of an essence
n. the balance being deionized water

### Manufacture

The composition can be prepared by conventional manufacturing process and equipments for producing daily chemicals. Under certain temperature (50-55° C.) and mixing speed (80 RPM), the raw materials are added into mixing equipment in order. During the process, the deionized water is added first, and then the quaternary ammonium compounds, alkylamine and guanidine. After the compounds are completely dissolved, the surfactant and penetrant are added, following by chelant, pH regulator, essence and colorant. PH value of the final products will be adjusted to 8±0.5. After filtration and quality control procedures, the products will be pumped into elevated tank, dispensed into empty bottles by filling machine, and then packaged.

### Test Methods

### Determination of Disinfection Efficacy

The disinfection efficacy of the cleaner was tested following the Technical Specifications for Disinfection of the Ministry of Health of China (2002). For this purpose, the cleaner to be tested was mixed with water at 1:40 ratio. The results of the disinfection effectiveness evaluations are summarized in Table 1.

TABLE 1
Disinfection Efficacy of the Composite Disinfectant Cleaner

| | Killing Logarithm Value |
|---|---|
| Microorganisms | (contact time 3 min.) |
| staphylococcus aureus and colibacillus | >5.0 |
| candida albicans | >4.0 |
| legionella bacteria | >5.0 |
| natural bacteria | >1.0 |

### Determination of Cleaning Performance

The cleaning performance of the disinfectant cleaner was tested following the Test Methods of Cleaning Performance (National Standards of China, GB/T15815-1995); the cleaner has 99% of the standard cleaning agent's performance.

### Advantages

From the description above, a number of advantages of some embodiments of the disinfectant cleaner become evident: rapid action in a broad antimicrobial spectrum, strong cleaning performance, non-toxic and non-irritating. It is effective for cleaning stains and disinfecting bacteria from hard surfaces such as filters of air conditioners, laundry machines, ceramic tiles and glass.

### CONCLUSION, RAMIFICATIONS, AND SCOPE

Accordingly, the reader will see that the application provides a non-toxic, non-irritating, and rapid action disinfectant cleaner with high disinfection efficacy and strong cleaning performance. It can be used in a variety of industrial and home applications, include hospitals, food and drink process facilities, filters of central air systems, filters of air conditioners, disinfection of pets, disinfection napkins and etc.

While the description above contains couple of specificities, these should not be construed as limiting the scope of the embodiments but as merely providing examples of some of the presently preferred embodiments. Thus the scope of the embodiments should be determined by the appended claims and their legal equivalents, rather than by the examples given. In addition, other variations and modifications of this application will be obvious to those skilled in the art.

We claim:

1. A composite disinfectant cleaner which, on a total composition weight basis, comprises:
a. about 0.5-0.7 weight percent of an alkyl dimethyl benzyl ammonium chloride
b. about 0.3-0.5 weight percent of an octyl decyl dimethyl ammonium chloride
c. about 0.1-0.2 weight percent of a dioctyl dimethyl ammonium chloride
d. about 0.2-0.3 weight percent of a didecyl dimethyl ammonium chloride
e. about 0.5-2 weight percent of an alkylamine
f. about 0.3-1.5 weight percent of a guanidine
g. about 10-20 weight percent of a penetrant
h. about 5-10 weight percent of a surfactant
i. about 0.1-0.6 weight percent of a chelant
j. about 0.05-0.1 weight percent of an essence
k. the balance being deionized water.

2. The composite disinfectant cleaner of claim 1 wherein said alkylamine is one of cetyl amidopropyl glycine, cetyl propylenediamine, cetyl dipropylenetriamine or their compounds.

3. The composite disinfectant cleaner of claim 1 wherein said guanidine is one of polihexanide, cyclohexen biguanide, chlorhexidine hydrochloride, chlorhexidine acetate or their compounds.

4. The composite disinfectant cleaner of claim 1 wherein said penetrant is one of ethanol, isopropanol, ethyl glycol, ethylene glycol monobutyl, propylene glycol monomethyl ether, diethylene glycol monoethyl ether, dipropylene glycol methyl ether or their compounds.

5. The composite disinfectant cleaner of claim 1 wherein said surfactant is one of lauryl dimethyl amine oxide, octyl dimethyl amine oxide, polyoxyethylene nonylphenol ether, dodecyl dimethyl betaine or their compounds.

6. The composite disinfectant cleaner of claim 1 wherein said essence is one of lavender essence, aloe essence, or lemon essence.
